(19) United States
(12) Patent Application Publication
(10) Pub. No.: US 2024/0127766 A1
(43) Pub. Date: Apr. 18, 2024

(54) TIMING CONTROLLER, POLARITY GRAYSCALE COMPENSATION METHOD, AND DISPLAY PANEL

(71) Applicant: TCL CHINA STAR OPTOELECTRONICS TECHNOLOGY CO., LTD., Shenzhen (CN)

(72) Inventors: Yonglei ZHANG, Shenzhen (CN); Tao HE, Shenzhen (CN); Jhenwei HE, Shenzhen (CN)

(21) Appl. No.: 17/297,706

(22) PCT Filed: Apr. 16, 2021
(86) PCT No.: PCT/CN2021/087844

§ 371 Date: Dec. 18, 2023

(30) Foreign Application Priority Data
Apr. 7, 2021 (CN) 202110371259.7

(51) Int. Cl. G09G 3/36

(52) U.S. Cl. CPC G09G 3/3607; G09G 3/3614; G09G 2320/028

(57) ABSTRACT

The present application discloses a timing controller, a polarity grayscale compensation method, and a display panel. The timing controller includes a viewing angle compensation module, an overdriving module, a lookup module, and a compensation module. A corresponding grayscale compensation table is looked up according to a comparison result of a previous frame image data and a current frame image data, a grayscale compensation is performed on the current frame image data after overdriving processing to generate a data signal after grayscale compensation, which can decrease occurrences of bright and dark lines when time-domain viewing angle compensation is switched between frames.

### TECHNICAL FIELD

The present disclosure relates to the field of display technology, and in particular to a timing controller, a polarity grayscale compensation method, and a display panel.

### BACKGROUND

When a display panel adopts pure spatial viewing angle compensation, a grayscale of a same sub-pixel does not change between frames. For example, as shown in FIG. 1, when a same sub-pixel has a high grayscale H in a first frame F1, it still has the high grayscale H in a second frame F2; and when the same sub-pixel has a low grayscale L in the first frame F1, it still has the low grayscale L in the second frame F2, which will bring certain granular sensation and reduce resolution of a screen.

Based on the above-mentioned use of pure spatial viewing angle compensation, it is also possible to switch between high and low grayscales in time, i.e., a time domain viewing angle compensation (VAC). For example, as shown in FIG. 2, when a same sub-pixel has the high grayscale H in the first frame F1, it is switched to the low grayscale L in the second frame F2; and when the same sub-pixel has the low gray L in the first frame F1, it is switched to the high grayscale H in the second frame F2, which can remedy the graininess while ensuring a certain viewing angle quality.

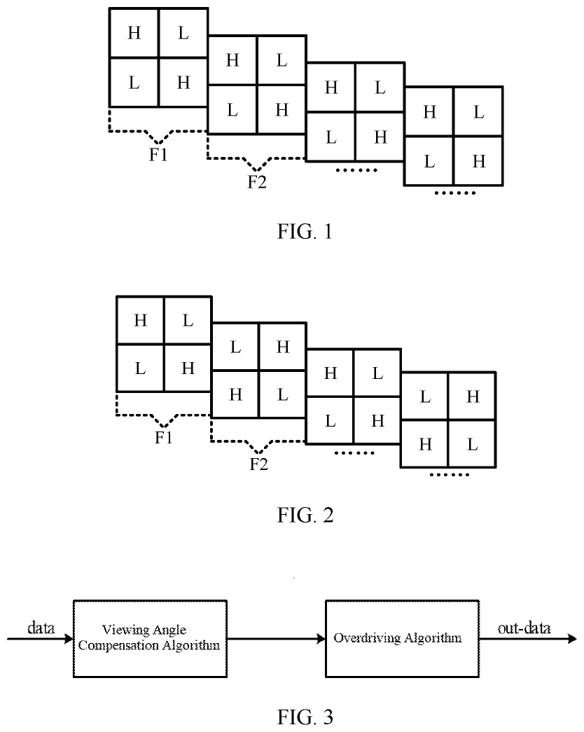

However, in a display panel using the time domain VAC, as shown in FIG. 3, an initial data signal data is generally processed by a time domain compensation algorithm and an overdriving algorithm in turn, and then directly outputs a target data signal out-data without any grayscale compensation. When switching between frames, bright dark lines or screen flickering are easy to form.

It should be noted that the above introduction of the background technology is only to facilitate a clear and complete understanding of the technical solutions of the present disclosure. Therefore, it cannot be considered that the above-mentioned technical solutions involved are known to those skilled in the art just because it appears in the background art of the present disclosure.

### SUMMARY

### Technical Problem

The present disclosure provides a timing controller, a polarity grayscale compensation method, and a display panel to alleviate a technical problem that bright and dark lines or shaking head lines are prone to appear when a time domain viewing angle compensation is switched between frames.

### Solutions for Problem

### Technical Solutions

In a first aspect, the present disclosure provides a timing controller, comprising: a viewing angle compensation module configured to output a corresponding frame image data according to a data signal accessed, wherein the frame image data comprises a previous frame image data and a current frame image data; an overdriving module, connected to the viewing angle compensation module, and configured to overdriving process the current frame image data and buffer the previous frame image data; a lookup module, connected to the viewing angle compensation module and the overdriving module, and configured to look up a corresponding grayscale compensation table according to a comparison result of the previous frame image data and the current frame image data; and a compensation module connected to the overdriving module and the lookup module, and configured to perform grayscale compensation on the current frame image data after the overdriving processing according to the grayscale compensation table to output a data signal after the grayscale compensation.

In some embodiments, the overdriving module comprises: an overdriving unit, connected to the viewing angle compensation module and the lookup module, and configured to overdriving process the current frame image data; and a storage unit connected to the viewing angle compensation module and the lookup module, and configured to buffer the previous frame image data.

In some embodiments, the lookup module comprises: a comparison unit, connected to the viewing angle compensation module and the storage unit, and configured to determine the comparison result according to a difference between the current frame image data and the previous frame image data; and a lookup unit connected to the comparison unit and the compensation module, and configured to look up and output the corresponding grayscale compensation table to the compensation module according to the comparison result.

In some embodiments, the frame image data comprises polarity data and grayscale data of at least one sub-pixel; when the polarity data of the sub-pixel jumps from a negative polarity to a positive polarity, and the grayscale data of the sub-pixel jumps from a low grayscale to a high grayscale, a grayscale compensation value of the sub-pixel in the grayscale compensation table is a corresponding point value on a first grayscale compensation curve.

In some embodiments, when the polarity data of the sub-pixel jumps from the negative polarity to the positive polarity, and the grayscale data of the sub-pixel jumps from the high grayscale to the low grayscale, the grayscale compensation value of the sub-pixel in the grayscale compensation table is a corresponding point value on a second grayscale compensation curve; and wherein the first grayscale compensation curve is different from the second grayscale compensation curve.

In some embodiments, when the polarity data of the sub-pixel jumps from the positive polarity to the negative polarity, and the grayscale data of the sub-pixel jumps from the low grayscale to the high grayscale, the grayscale compensation value of the sub-pixel in the grayscale compensation table is a corresponding point value on a third grayscale compensation curve; and wherein the second grayscale compensation curve is different from the third grayscale compensation curve.

In some embodiments, when the polarity data of the sub-pixel jumps from the positive polarity to the negative polarity, and the grayscale data of the sub-pixel jumps from the high grayscale to the low grayscale, the grayscale compensation value of the sub-pixel in the grayscale compensation table is a corresponding point value on a fourth grayscale compensation curve; and wherein the third grayscale compensation curve is different from the fourth grayscale compensation curve.

In some embodiments, at least one of the first grayscale compensation curve, the second grayscale compensation curve, the third grayscale compensation curve, or the fourth grayscale compensation curve is a quadratic function with different curvatures; and wherein a bending direction of the first grayscale compensation curve is different from a bending direction of at least one of the second grayscale compensation curve, the third grayscale compensation curve, or the fourth grayscale compensation curve.

In some embodiments, a curvature of the fourth grayscale compensation curve is greater than a curvature of the second grayscale compensation curve; the curvature of the second grayscale compensation curve is greater than a curvature of the first grayscale compensation curve; and the curvature of the first grayscale compensation curve is greater than a curvature of the third grayscale compensation curve.

In a second aspect, the present disclosure provides a polarity grayscale compensation method, comprising: based on a viewing angle compensation algorithm, outputting a corresponding frame image data in response to a data signal accessed, wherein the frame image data comprises a previous frame image data and a current frame image data; based on an overdriving algorithm, overdriving processing the current frame image data and buffering the previous frame of image data; and according to a comparison result of the previous frame image data and the current frame image data, looking up a corresponding grayscale compensation table; and according to the grayscale compensation table, performing grayscale compensation on the current frame image data after overdriving processing to output a data signal after the grayscale compensation.

In a third aspect, the present disclosure provides a display panel comprising the timing controller in any of the embodiments.

### Beneficial Effects of the Invention

### Beneficial Effects

The timing controller, the polarity grayscale compensation method, and the display panel provided by the present disclosure look up the corresponding grayscale compensation table based on the comparison result of the previous frame image data and the current frame image data, so as to perform the overdriving processing on the current frame image data and then generate the data signal OUT-DATA after grayscale compensation, which can decrease the bright and dark lines or the screen flickering when the time domain viewing angle compensation is switched between frames.

### ILLUSTRATION OF THE DRAWINGS

### Description of Drawings

FIG. 1 is a schematic structural diagram of sub-pixel grayscales during pure spatial viewing angle compensation.

FIG. 2 is a schematic structural diagram of sub-pixel grayscales during a time domain viewing angle compensation.

FIG. 3 is a schematic structural diagram of a time domain viewing angle compensation in a traditional technical solution.

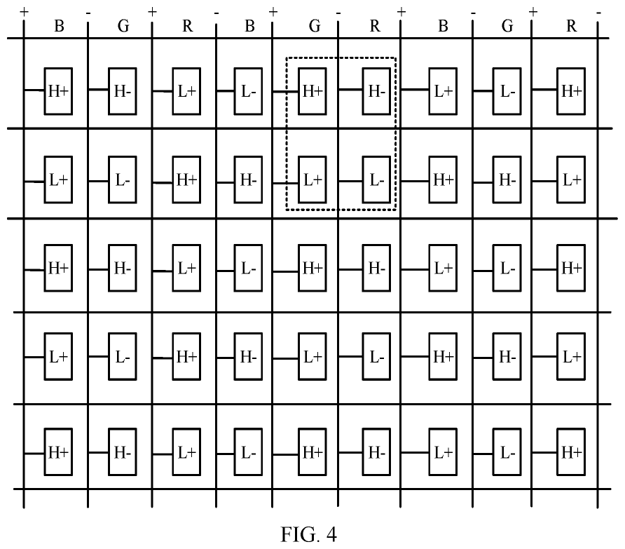

FIG. 4 is a schematic structural diagram of grayscale and polarity distribution of sub-pixels.

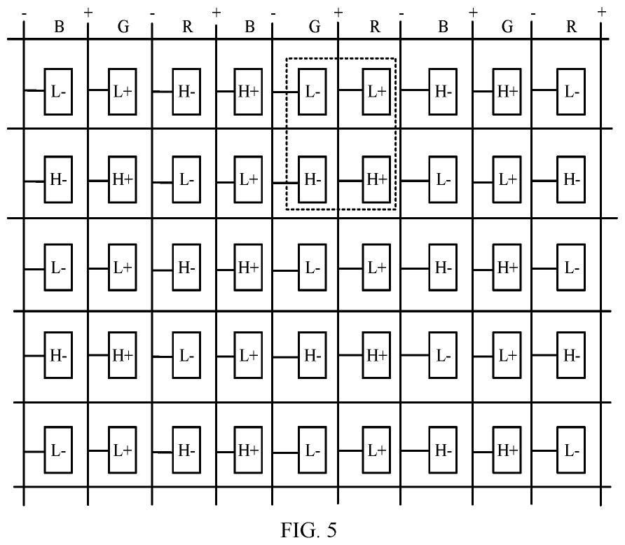

FIG. 5 is another schematic structural diagram grayscale and polarity distribution of sub-pixels.

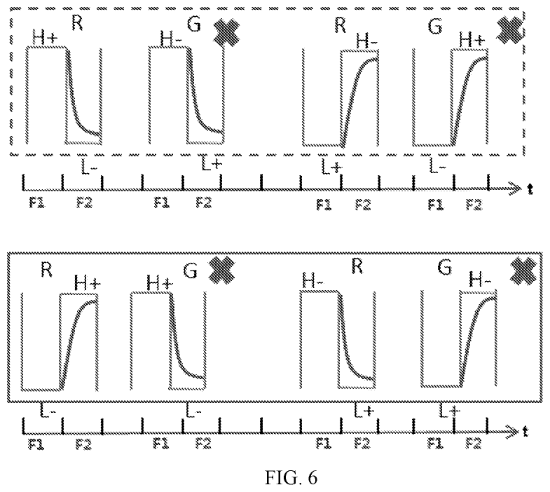

FIG. 6 is a schematic diagram of brightness analysis during the time domain viewing angle compensation.

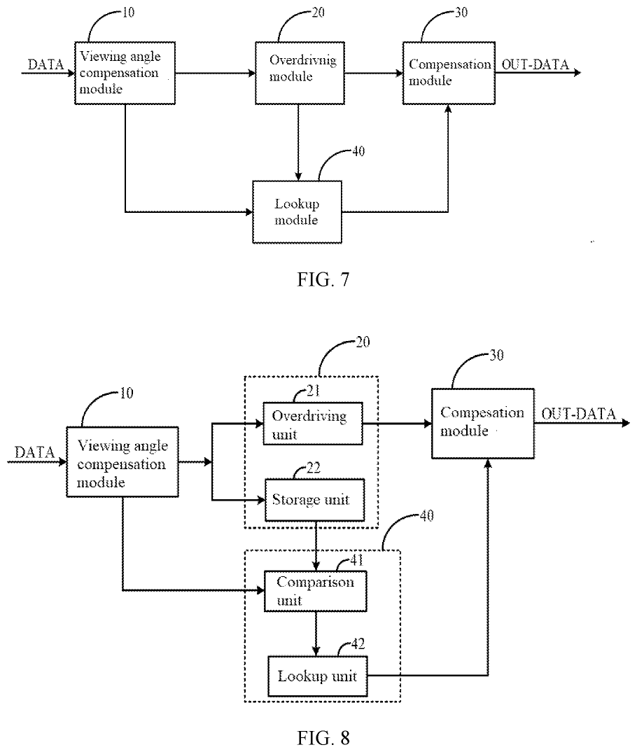

FIG. 7 is a schematic structural diagram of a timing controller provided by an embodiment of the present disclosure.

FIG. 8 is another schematic structural diagram of a timing controller provided by an embodiment of the present disclosure.

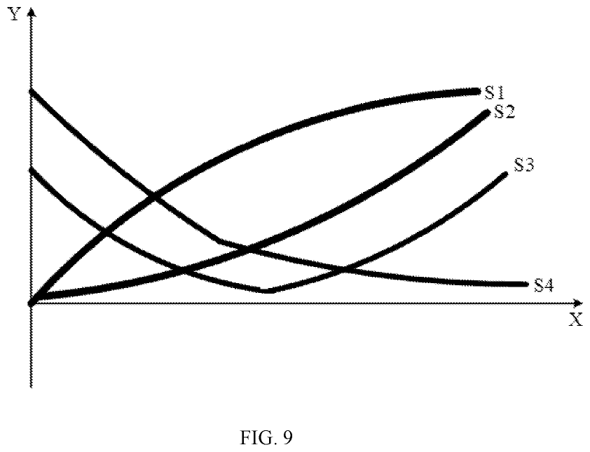

FIG. 9 is a schematic diagram of grayscale compensation curves provided by an embodiment of the present disclosure.

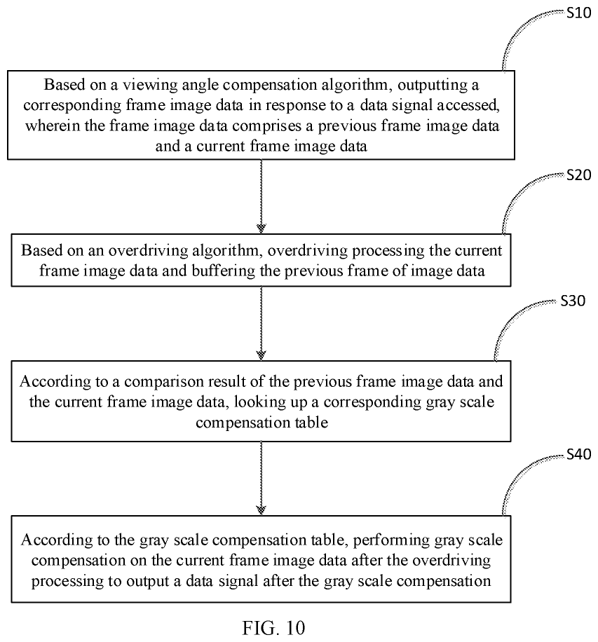

FIG. 10 is a schematic flowchart of a polarity grayscale compensation method provided by an embodiment of the present disclosure.

### IMPLEMENTATIONS OF THE INVENTION

### Detailed Description of Embodiments

In order to make the purpose, technical solution and effect of the present disclosure more clear and definite, the present disclosure is further described in detail with reference to the attached drawings and embodiments. It should be understood that the specific embodiments described herein are only used to explain the present disclosure and are not used to limit the present disclosure.

Please refer to FIGS. 1-10. Based on the above-mentioned bright and dark lines or screen flickering, long term research has found that during the time domain viewing angle compensation process, as shown in FIG. 4, polarity of each sub-pixel column is alternately arranged in sequence. For example, a blue sub-pixel column may comprise a plurality of blue sub-pixels B arranged along a first direction, polarity in a previous frame is a positive polarity+, and grayscales in the previous frame have a high grayscale H and a low grayscale L appeared alternately along a direction of the blue sub-pixel column. A green sub-pixel column may comprise a plurality of green sub-pixels G arranged along the first direction, polarity in the previous frame is a negative polarity−, and grayscales in the previous frame have the high grayscale H and the low grayscale L appeared alternately along the direction of the blue sub-pixel column. A red sub-pixel column may comprise a plurality of red sub-pixels R arranged along the first direction, polarity in the previous frame is the positive polarity+, and grayscales in the previous frame have the high grayscale H and the low grayscale L appeared alternately along the direction of the blue sub-pixel column.

As shown in FIGS. 4 and 5, when switching polarities between frames, polarity and grayscale of a corresponding sub-pixel column are reversed. For example, when polarity of a same sub-pixel in the previous frame is the positive polarity+, then in the present frame, the polarity of the sub-pixel is reversed to the negative polarity−; or the polarity of the same sub-pixel in the previous frame is the negative polarity−, then in the present frame, the polarity of the sub-pixel is reversed to the positive polarity+. When grayscale of a same sub-pixel in the previous frame is the high grayscale H, then in the present frame, the grayscale of the sub-pixel is reversed to the low grayscale L; or when the grayscale of the same sub-pixel in the previous frame is the low grayscale L, and then in the present frame, the grayscale of the sub-pixel is reversed to the high grayscale H. The sub-pixel may be any of the blue sub-pixel B, the green sub-pixel G, or the red sub-pixel R.

As shown in FIG. 4 to FIG. 6, a switch between the high grayscale H and the low grayscale L is performed from a first frame F1 to a second frame F2. As shown by a dashed box in FIG. 6, during the first frame F1 to the second frame F2, one of the red sub-pixels R switches from the positive polarity+ and the high grayscale H to the negative polarity− and the low grayscale L; and another red sub pixel R switches from the positive polarity+ and the low grayscale L to the negative polarity− and the high grayscale H. One of the green sub-pixels G switches from the negative polarity− and the high grayscale H to the positive polarity+ and the low grayscale L; and another green sub pixel G switches from the negative polarity− and the low grayscale L to the positive polarity+ and the high grayscale H. As shown by a solid frame in FIG. 6, one of the red sub-pixels R switches from the negative polarity− and the high grayscale H to the positive polarity+ and the low grayscale L; and another red sub-pixel R switches from the negative polarity− and the low grayscale Level L to the positive polarity+ and the high grayscale H. One of the green sub-pixels G switches from the positive polarity+ and the high grayscale H to the negative polarity− and the low grayscale L; and another green sub pixel G switches from the positive polarity+ and the low grayscale L to the negative polarity− and the high grayscale H. Crosses X shown in FIG. 6 indicate that when the high grayscale H and the low grayscale L are switched, due to asymmetry of liquid crystal reaction time, brightness of sub-pixels with different polarities and a same grayscale are different, for example, a sub-pixel with the positive polarity+ and the high grayscale H and a sub-pixel with the negative polarity− and the high grayscale H have different brightness, and finally the above-mentioned bright dark lines or screen flickering are formed.

As shown in FIG. 7, based on the above analysis, the present embodiment provides a timing controller, which comprises a viewing angle compensation module 10, an overdriving module 20, a lookup module 40, and a compensation module 30. The viewing angle compensation module 10 is configured to output a corresponding frame image data according to a data signal DATA accessed, and the frame image data comprises a previous frame image data and a current frame image data. The overdriving module 20 is connected with the viewing angle compensation module 10, and is configured to overdriving process the current frame image data and buffer the previous frame image data. The lookup module 40 is connected to the viewing angle compensation module 10 and the overdriving module 20, and is configured to lookup a corresponding grayscale compensation table according to a comparison result of the previous frame image data and the current frame image data. The compensation module 30 is connected to the overdriving module 20 and the lookup module 40, and configured to perform grayscale compensation on the current frame image data after the overdriving process according to the grayscale compensation table, so as to output a data signal OUT-DATA after grayscale compensation.

It can be understood that the timing controller provided in the present embodiment looks up the corresponding grayscale compensation table based on the comparison result of the previous frame image data and the current frame image data, so as to perform the grayscale compensation on the current frame image data after overdriving process, and then generates the data signal OUT-DATA after the grayscale compensation, which can decrease bright and dark lines or screen flickering when the time domain viewing angle compensation is switched between frames.

It should be noted that the viewing angle compensation module 10 in the present embodiment may be, but is not limited to, being constructed and formed based on a time domain viewing angle compensation algorithm. The overdriving module 20 may be, but not limited to, being constructed based on an overdriving algorithm.

Wherein, the previous frame image data is always buffered in the overdriving module 20, and the previous frame image data may be, but not limited to, the previous frame image data that has not been processed by the overdriving algorithm, it can also be the previous frame image data that has been processed by the overdriving algorithm.

As shown in FIG. 8, in one of the embodiments, the overdriving module 20 comprises an overdriving unit 21 and a storage unit 22. The overdriving unit 21 is connected to the viewing angle compensation module 10 and the lookup module 40 and is configured to overdriving process the current frame image data. The storage unit 22 is connected to the viewing angle compensation module 10 and the lookup module 40 and configured to buffer the previous frame image data.

As shown in FIG. 8, in one of the embodiments, the lookup module 40 comprises a comparison unit 41 and a lookup unit 42. The comparison unit 41 is connected to the viewing angle compensation module 10 and the storage unit 22, and is configured to determine the comparison result according to a difference between the current frame image data and the previous frame image. The lookup unit 42 is connected to the comparison unit 41 and the compensation module 30 and is configured to look up and output the corresponding grayscale compensation table to the compensation module 30 according to the comparison result.

As shown in FIG. 9, in one of the embodiments, the frame image data comprises polarity data and grayscale data of at least one sub-pixel. When the polarity data of the sub-pixel jumps from the negative polarity to the positive polarity, and the grayscale of the sub-pixel jumps from the low grayscale to the high grayscale, a grayscale compensation value of the sub-pixel in the grayscale compensation table is a corresponding point value on a first grayscale compensation curve S1.

In one of the embodiments, when the polarity data of the sub-pixel jumps from the negative polarity to the positive polarity, and the grayscale data of the sub-pixel jumps from the high grayscale to the low grayscale, the grayscale compensation value of the sub-pixel in the grayscale compensation table is a corresponding point value on a second grayscale compensation curve S2; wherein, the first grayscale compensation curve S1 is different from the second grayscale compensation curve S2.

In one of the embodiments, when the polarity data of the sub-pixel jumps from the positive polarity to the negative polarity, and the grayscale data of the sub-pixel jumps from the low grayscale to the high grayscale, the grayscale compensation value of the sub-pixel in the grayscale compensation table is a corresponding point value on a third grayscale compensation curve S3; wherein, the second grayscale compensation curve S2 is different from the third grayscale compensation curve S3.

In one of the embodiments, when the polarity data of the sub-pixel jumps from the positive polarity to the negative polarity, and the grayscale data of the sub-pixel jumps from the high grayscale to the low grayscale, the grayscale compensation value of the sub-pixel in the grayscale compensation table is a corresponding point value on a fourth grayscale compensation curve S4; wherein, the third grayscale compensation curve S3 is different from the fourth grayscale compensation curve S4.

In one of the embodiments, at least one of the first grayscale compensation curve S1, the second grayscale compensation curve S2, the third grayscale compensation curve S3, or the fourth grayscale compensation curve S4 is a quadratic function with different curvatures. Wherein, a bending direction of the first grayscale compensation curve S1 is different from a bending direction of at least one of the second grayscale compensation curve S2, the third grayscale compensation curve S3, or the fourth grayscale compensation curve S4.

In one of the embodiments, a curvature of the fourth grayscale compensation curve S4 is greater than a curvature of the second grayscale compensation curve S2; the curvature of the second grayscale compensation curve S2 is greater than a curvature of the first grayscale compensation curve S1; and the curvature of the grayscale compensation curve S1 is greater than a curvature of the third grayscale compensation curve S3.

It can be understood that different grayscale compensation curves can compensate for polarity and grayscale jumps of different combination types. Wherein, any one of the first grayscale compensation curve S1, the second grayscale compensation curve S2, the third grayscale compensation curve S3, or the fourth grayscale compensation curve S4 can be determined according to some point values, then an interpolation calculation is performed based on these point values to obtain other point values on a same grayscale compensation curve.

Wherein, as shown in FIG. 9, a point value on the X-axis can represent a grayscale value of a sub-pixel in the current frame image data minus a grayscale value of the sub-pixel in the previous frame image data, and a point value on the Y-axis can represent a grayscale compensation value. According to the corresponding grayscale compensation curve, the grayscale compensation value on the Y-axis direction corresponding to the point value on the X-axis can be determined.

The point value on the X-axis can be at least one of 0, 1, 8, 16, 48, 96, 128, 164, 192, 224, 255, and 256, and the corresponding grayscale compensation value, i.e., the point value on the Y-axis corresponds to any of 0, 0, 2, 5, 5, 6, 7, 4, 3, 2, 1, and 0. Wherein, the grayscale compensation value on the Y-axis can be flexibly set according to the bright and dark lines or the screen flickering of the display panel, and then the corresponding complete grayscale compensation curve can be obtained through the linear interpolation.

Based on different grayscale compensation values of each sub-pixel, the corresponding grayscale compensation table can be made, and then the corresponding grayscale compensation table can be used to uniformly compensate the grayscale of the corresponding sub-pixel in a same frame, the current frame image data compensated by the corresponding grayscale compensation table can overcome brightness difference shown by the same sub-pixel of different polarities and the same grayscale during frame switching, thereby weakening the bright and dark lines or the screen flickering.

As shown in FIG. 10, in one of the embodiments, the present embodiment provides a polarity grayscale compensation method, which comprises the following steps:

Step S10: based on a viewing angle compensation algorithm, outputting a corresponding frame image data in response to a data signal accessed, wherein the frame image data comprises a previous frame image data and a current frame image data.

Step S20: based on an overdriving algorithm, overdriving processing the current frame image data and buffering the previous frame image data.

Step S30: according to a comparison result of the previous frame image data and the current frame image data, looking up a corresponding grayscale compensation table.

Step S40: according to the grayscale compensation table, performing grayscale compensation on the current frame image data after the overdriving processing to output a data signal after grayscale compensation.

It can be understood that the polarity grayscale compensation method provided in this embodiment looks up the corresponding grayscale compensation table based on the comparison result of the previous frame image data and the current frame image data, so as to perform the overdriving processing on the current frame image data, and then generates the data signal OUT-DATA after grayscale compensation, which can decrease the bright and dark lines or the screen flickering when the time domain viewing angle compensation is switched between frames.

In one of the embodiments, this embodiment provides a display panel, which may comprise the timing controller in any of the above embodiments.

It can be understood that the display panel provided in this embodiment looks up the corresponding grayscale compensation table based on the comparison result of the previous frame image data and the current frame image data, so as to perform the overdriving processing on the current frame image data, and then generates the data signal OUT-DATA after grayscale compensation, which can decrease the bright and dark lines or the screen flickering when the time domain viewing angle compensation is switched between frames.

The display panel may further comprise a source driver; the timing controller is connected to the source driver to receive data signal output by the timing controller.

In one of the embodiments, the display panel may be a liquid crystal display panel, specifically, it may be a vertical alignment (VA) display panel, and the VA display panel may be a wide viewing angle display panel, which is convenient for multiple people to watch at the same time.

In one of the embodiments, this embodiment provides a display device, which may comprise the display panel in any of the above embodiments.

It can be understood that the display device provided in this embodiment looks up the corresponding grayscale compensation table based on the comparison result of the previous frame image data and the current frame image data, so as to perform the overdriving processing on the current frame image data, and then generates the data signal OUT-DATA after grayscale compensation, which can decrease the bright and dark lines or the screen flickering when the time domain viewing angle compensation is switched between frames.

It can be understood that, for those of ordinary skill in the art, equivalent replacements or changes can be made according to the technical solution of the present disclosure and its inventive concept, and all these changes or replacements shall fall within the protection scope of the appended claims of the present disclosure.

1. A timing controller, comprising:
a viewing angle compensation module configured to output a corresponding frame image data according to a data signal accessed, wherein the frame image data comprises a previous frame image data and a current frame image data;
an overdriving module connected to the viewing angle compensation module, and configured to overdriving process the current frame image data and buffer the previous frame image data;
a lookup module connected to the viewing angle compensation module and the overdriving module and configured to look up a corresponding grayscale compensation table according to a comparison result of the previous frame image data and the current frame image data; and
a compensation module connected to the overdriving module and the lookup module and configured to perform grayscale compensation on the current frame image data after the overdriving processing according to the grayscale compensation table to output a data signal after the grayscale compensation.

2. The timing controller according to claim 1, wherein the overdriving module comprises:
an overdriving unit connected to the viewing angle compensation module and the lookup module, and configured to overdriving process the current frame image data; and
a storage unit connected to the viewing angle compensation module and the lookup module, and configured to buffer the previous frame image data.

3. The timing controller according to claim 2, wherein the lookup module comprises:
a comparison unit connected to the viewing angle compensation module and the storage unit and configured to determine the comparison result according to a difference between the current frame image data and the previous frame image data; and
a lookup unit connected to the comparison unit and the compensation module, and configured to look up and output the corresponding grayscale compensation table to the compensation module according to the comparison result.

4. The timing controller according to claim 1, wherein the frame image data comprises polarity data and grayscale data of at least one sub-pixel; when the polarity data of the sub-pixel jumps from a negative polarity to a positive polarity, and the grayscale data of the sub-pixel jumps from a low grayscale to a high grayscale, a grayscale compensation value of the sub-pixel in the grayscale compensation table is a corresponding point value on a first grayscale compensation curve.

5. The timing controller according to claim 4, wherein when the polarity data of the sub-pixel jumps from the negative polarity to the positive polarity, and the grayscale data of the sub-pixel jumps from the high grayscale to the low grayscale, the grayscale compensation value of the sub-pixel in the grayscale compensation table is a corresponding point value on a second grayscale compensation curve; and
wherein the first grayscale compensation curve is different from the second grayscale compensation curve.

6. The timing controller according to claim 5, wherein when the polarity data of the sub-pixel jumps from the positive polarity to the negative polarity, and the grayscale data of the sub-pixel jumps from the low grayscale to the high grayscale, the grayscale compensation value of the sub-pixel in the grayscale compensation table is a corresponding point value on a third grayscale compensation curve; and
wherein the second grayscale compensation curve is different from the third grayscale compensation curve.

7. The timing controller according to claim 6, wherein when the polarity data of the sub-pixel jumps from the positive polarity to the negative polarity, and the grayscale data of the sub-pixel jumps from the high grayscale to the low grayscale, the grayscale compensation value of the sub-pixel in the grayscale compensation table is a corresponding point value on a fourth grayscale compensation curve; and
wherein the third grayscale compensation curve is different from the fourth grayscale compensation curve.

8. The timing controller according to claim 7, wherein at least one of the first grayscale compensation curve, the second grayscale compensation curve, the third grayscale compensation curve, or the fourth grayscale compensation curve is a quadratic function with different curvatures; and
wherein a bending direction of the first grayscale compensation curve is different from a bending direction of at least one of the second grayscale compensation curve, the third grayscale compensation curve, or the fourth grayscale compensation curve.

9. The timing controller according to claim 8, wherein a curvature of the fourth grayscale compensation curve is greater than a curvature of the second grayscale compensation curve; the curvature of the second grayscale compensation curve is greater than a curvature of the first grayscale compensation curve; and the curvature of the first grayscale compensation curve is greater than a curvature of the third grayscale compensation curve.

10. A polarity grayscale compensation method, comprising:
outputting a corresponding frame image data in response to a data signal accessed based on a viewing angle compensation algorithm, wherein the frame image data comprises a previous frame image data and a current frame image data;
overdriving processing the current frame image data and buffering the previous frame of image data based on an overdriving algorithm; and
looking up a corresponding grayscale compensation table according to a comparison result of the previous frame image data and the current frame image data; and
performing grayscale compensation on the current frame image data after overdriving processing to output a data signal after the grayscale compensation according to the grayscale compensation table.

11. A display panel comprising the timing controller according to claim 1.

12. The display panel according to claim 11, wherein the display panel further comprises a source driver, and the source driver is connected to the timing controller.

13. The display panel according to claim 12, wherein the overdriving module comprises:
an overdriving unit connected to the viewing angle compensation module and the lookup module and configured to overdriving process the current frame image data; and
a storage unit connected to the viewing angle compensation module and the lookup module and configured to buffer the previous frame image data.

14. The display panel according to claim 13, wherein the lookup module comprises:
a comparison unit connected to the viewing angle compensation module and the storage unit, and configured to determine the comparison result according to a difference between the current frame image data and the previous frame image data; and
a lookup unit connected to the comparison unit and the compensation module, and configured to look up and output the corresponding grayscale compensation table to the compensation module according to the comparison result.

15. The display panel according to claim 12, wherein the frame image data comprises polarity data and grayscale data of at least one sub-pixel; when the polarity data of the sub-pixel jumps from a negative polarity to a positive polarity, and the grayscale data of the sub-pixel jumps from a low grayscale to a high grayscale, a grayscale compensation value of the sub-pixel in the grayscale compensation table is a corresponding point value on a first grayscale compensation curve.

16. The display panel according to claim 15, wherein when the polarity data of the sub-pixel jumps from the negative polarity to the positive polarity, and the grayscale data of the sub-pixel jumps from the high grayscale to the low grayscale, the grayscale compensation value of the sub-pixel in the grayscale compensation table is a corresponding point value on a second grayscale compensation curve; and
wherein the first grayscale compensation curve is different from the second grayscale compensation curve.

17. The display panel according to claim 16, wherein when the polarity data of the sub-pixel jumps from the positive polarity to the negative polarity, and the grayscale data of the sub-pixel jumps from the low grayscale to the high grayscale, the grayscale compensation value of the sub-pixel in the grayscale compensation table is a corresponding point value on a third grayscale compensation curve; and
wherein the second grayscale compensation curve is different from the third grayscale compensation curve.

18. The display panel according to claim 17, wherein when the polarity data of the sub-pixel jumps from the positive polarity to the negative polarity, and the grayscale data of the sub-pixel jumps from the high grayscale to the low grayscale, the grayscale compensation value of the sub-pixel in the grayscale compensation table is a corresponding point value on a fourth grayscale compensation curve; and
wherein the third grayscale compensation curve is different from the fourth grayscale compensation curve.

19. The display panel according to claim 18, wherein at least one of the first grayscale compensation curve, the second grayscale compensation curve, the third grayscale compensation curve, or the fourth grayscale compensation curve is a quadratic function with different curvatures; and
wherein a bending direction of the first grayscale compensation curve is different from a bending direction of at least one of the second grayscale compensation curve, the third grayscale compensation curve, or the fourth grayscale compensation curve.

20. The display panel according to claim 19, wherein a curvature of the fourth grayscale compensation curve is greater than a curvature of the second grayscale compensation curve; the curvature of the second grayscale compensation curve is greater than a curvature of the first grayscale compensation curve; and the curvature of the first grayscale compensation curve is greater than a curvature of the third grayscale compensation curve.
